(19) United States
(12) Patent Application Publication
(10) Pub. No.: US 2006/0134586 A1
(43) Pub. Date: Jun. 22, 2006

(54) Tactile interface system

(75) Inventors: Francois-Dominique G. Armingaud, Paris (FR); Fernando D. Pedrazzoli, Madrid (ES); Jose M. Varona Barbero, Madrid (ES)

Correspondence Address: IBM CORPORATION, IPLAW IQ0A/40-3, 1701 NORTH STREET, ENDICOTT, NY, 13760, US

(73) Assignee: International Business Machines Corporation, Armonk, NY (US)

(21) Appl. No.: 11/289,340

(22) Filed: Nov. 29, 2005

(30) Foreign Application Priority Data
Dec. 21, 2004 (EP) 04300927.3

(51) Int. Cl. G09B 21/00

(52) U.S. Cl. 434/113

(57) ABSTRACT

A tactile interface system is disclosed comprising a information transmission unit and a tactile interface. The information transmission unit may be located in any information system and transmits information for reception by the tactile interface. The tactile interface has a plurality of tactile character reproduction devices which are controlled by a reception unit to reproduce the information transmitted by the information transmission unit to a user of the tactile interface. In a preferred embodiment the tactile interface is a Braille interface.

### TECHNICAL FIELD

The present invention relates to a tactile interface system and particularly, but not exclusively, to a wireless tactile interface system for visually impaired persons.

### BACKGROUND

Visually impaired persons may have difficulty in locating information and, in particular, signs or written information. Although tactile signs, such as Braille signs, allow them to read the information, they must first locate where the Braille signs are in a public area before they have the opportunity to read the information.

Under the Americans with Disabilities Act, visually impaired persons have the civil right to access information provided to other pedestrians.

That is, the information should flow to the visually impaired person instead of them searching to find where the information is located. The information should also only be sent to the intended persons, in this case visually impaired persons, and should not disrupt other persons with noise signals or the like.

Braille signs are used in many places to indicate places or services, such as restrooms, elevators or floor numbers, but they can be very inconvenient in that they have to be located in order to be used. Museums and buildings such as commercial shopping centers are placing indicator maps in Braille having the same inconvenience for the visually impaired, as described above.

Visually impaired persons may also be alerted to information and situations through audible signals, such as an audio signal for traffic lights. When the traffic is stopped and the pedestrian green light is on, an audio beep or birdcall is played so visually impaired persons can understand that it is safe to cross the street.

The audio signal is played for everybody to hear, not only visually impaired persons, and requires use of a sense that is already highly used in open space by visually impaired people: hearing. The visually impaired person has to listen for other warning noises, such as the engine of an approaching vehicle, which as technology has advanced, have become quieter making it difficult for visually impaired persons to recognize.

An audio signal can also be obstructed by surrounding “noise” such as noise from construction areas (not infrequent on the streets) such as pneumatic drills and hammers. These noises can confuse visually impaired persons as they may not hear an audio signal fully or at all. Statistics show that visually impaired persons are also confused with other similar sounds, such as mobile telephones or other electronic devices.

Pushbuttons on traffic lights to indicate that a person desires to cross a road are also an obstacle for visually impaired persons, as they may not know of their presence at a specific street intersection. In the event that they are aware of the pushbutton, it is still difficult to find its location. Locating buttons in other situations, such as elevators and other similar applications, have similar problems.

Text to voice converters which reproduce written text through audio representation of speech are available to visually impaired persons. Text to voice converters are mainly used for web page navigation and personal computer applications such as word processors. Text to voice converters may be inconvenient in that they are not very effective in noisy environments and also have the disadvantage that, normally, listening comprehension is lower than reading comprehension, reducing the effectiveness of the information.

Braille ruler devices, which reproduce written text from a screen to Braille characters on a pin surface, typically used for personal computers applications are also available. These Braille devices have disadvantages in that visually impaired persons have to find where the device is and be alert at all times when the information is being transmitted. In practice, a visually impaired person must have their fingers on top of the device at all times to be sure that they have received all of the information. In addition, the visually impaired person has to go to where the information is instead of the information flowing to the person.

Both the text to voice converter and Braille ruler device are focused and limited to Personal Computer applications and experiences.

### SUMMARY OF THE INVENTION

According to one aspect of the present invention there is provided a tactile interface system comprising an attaching means for attaching the tactile interface to at least one digit of a user, at least one tactile character reproduction device, located on the attaching means and proximal to a sensitive region of the at least one digit, and a reception means for receiving transmitted information, wherein the reception means provides the received information to the at least one tactile character reproduction device.

According to another aspect of the present invention, there is provided an information unit comprising a transmission means for transmitting information to a tactile interface including an attaching means for attaching the tactile interface to at least one digit of the user, at least one tactile character reproduction device, located on the attaching means and proximal to a sensitive region of the at least one digit, and a reception means for receiving transmitted information, wherein the reception means provides the received information to the at least one tactile character reproduction device.

According to yet another aspect of the present invention, there is provided a tactile interface system comprising an information transmission unit having a transmission means for transmitting information to a tactile interface including an attaching means for attaching the tactile interface to at least one digit of a user, at least one tactile character reproduction device, located on the attaching means and proximal to a sensitive region of the at least one digit, and a reception means for receiving transmitted information, wherein the reception means provides the received information to the at least one tactile character reproduction device.

### BRIEF DESCRIPTION OF THE DRAWINGS

Embodiments of the present invention will now be described with reference to the accompanying drawings, in which;

FIG. 1 illustrates an embodiment of a tactile interface system according to the present invention;

FIG. 2 illustrates an embodiment of tactile interface glove according to the present invention; and

FIG. 3 illustrates a flow diagram of a reception unit according to the present invention.

### DETAILED DESCRIPTION OF THE INVENTION

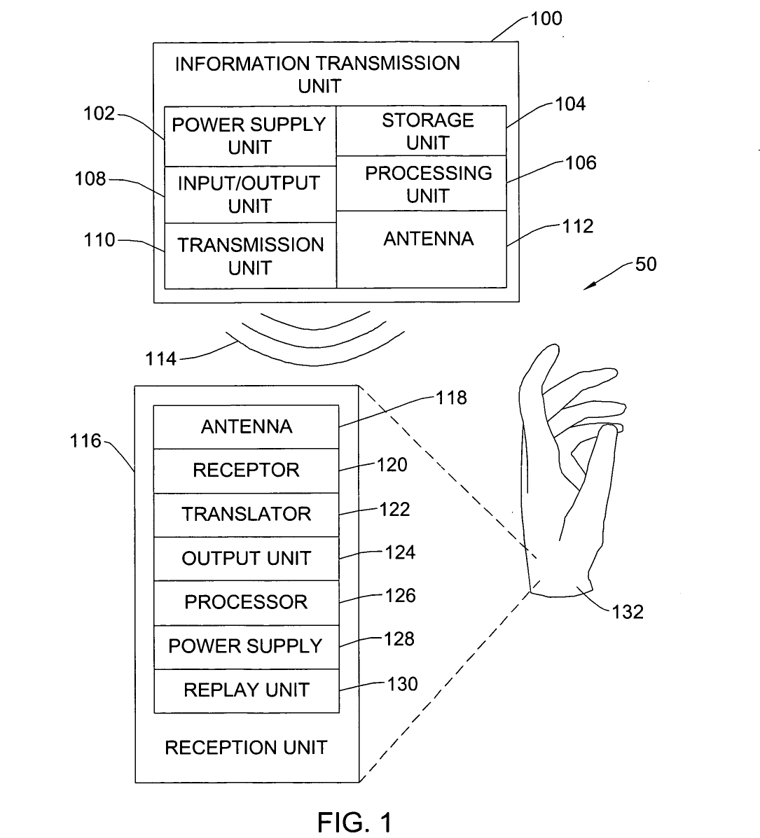

Referring to FIG. 1, an example of a tactile interface system, in this case a Braille interface system 50, comprises an information transmission unit (ITU) 100, for a sign (not shown), and a Braille glove interface 132.

The ITU 100 comprises a power supply unit 102, a processing unit 106, an Input/Output unit 108, a transmission module 110, a storage unit 104 and an antenna 112. Storage unit 104 contains information relating to the sign. The information is loaded into storage unit 104 at set up time and is updated as necessary if, for example, the status of the sign changes. Input/Output unit 108 enables ITU 100 to receive information for storing in storage unit 104 and also provides a communication route to send information out, such as content of the storage unit when requested by an external source, for controlling, monitoring or maintenance purposes. Processing unit 106 controls the reception, storage and transmission of the information. Processing unit 106 instructs transmission module 110 to transmit the information from storage unit 104 by way of antenna 112 at regular intervals.

Braille glove interface 132 has a reception unit 116 comprising an antenna 118, a receptor 120, a translator 122, an output unit 124, a processor 126, a power supply 128 for powering the interface 132 and a replay unit 130.

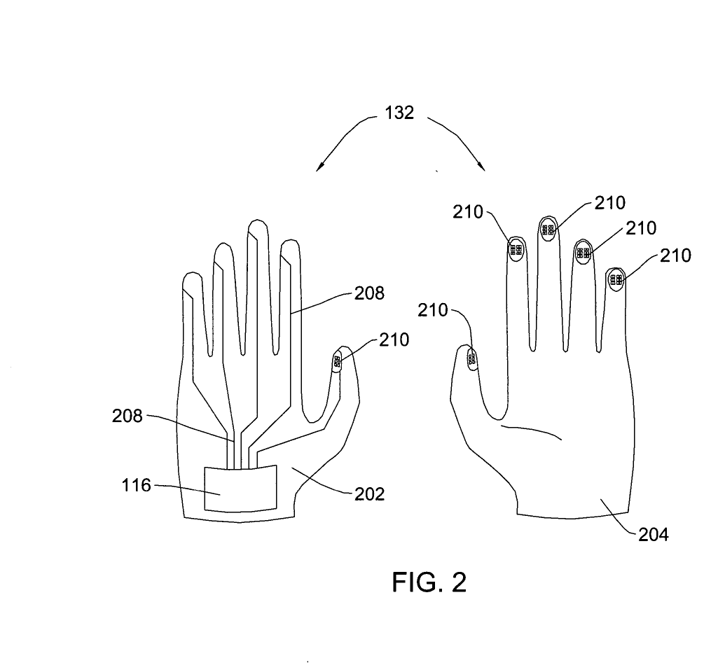

Antenna 118 facilitates the reception of the information sent by ITU 100, and is electrically connected to receptor 120. Translator 122 converts the information received into appropriate signals for a tactile character reproduction device, in this case a Braille Character Reproduction Device (BCRD) 210 (FIG. 2). Output unit 124 transmits the translated information signals to the BCRDs.

Replay unit 130 includes a digital storage device (not shown), such as a memory chip, and an interrupt device (not shown), such as a button or switch, to recognize a replay command executed by the user of interface 132. Replay unit 130 stores information sent by ITU 100 in the digital storage device and transmits the stored information to translator 122 when the interrupt device is activated. The stored information is then played to the user of interface 132.

Processor 126 controls all the processes of information reception, conversion and transmission to the BCRDs.

The wireless information transmission by ITU 100 for reception by reception unit 116 may be a Radio frequency (RF) connection, a wireless LAN (Local Area Network), a Bluetooth connection, GPRS connection, GSM connection, an infrared connection or any other wireless transmission connection.

Reception unit 116 and Braille glove interface 132 are further illustrated in the embodiment shown in FIG. 2. A back view 202 shows reception unit 116 located on the back hand side of interface 132. Flexible wiring 208 connects reception unit 116 to a BCRD 210 on each finger, as well as the thumb, of the glove interface 132. A palm view 204 illustrates the location of BCRDs 210 on the tips of each finger of glove interface 132.

Reception unit 116 may be located in any appropriate position on glove interface 132 itself or it may be an independent device, which may, for example, be placed in a pocket or attached to a belt. Reception unit 132 may communicate to BCRDs 210 by means of a cable or by means of a wireless connection, such as Bluetooth.

The BCRDs reproduce the pins of Braille characters by producing a pressure on the skin representing the area of a dot in the Braille sign to be reproduced. The pressure may be produced by an electrical pulse fed by power supply 128 located on interface 132 or by any other suitable means.

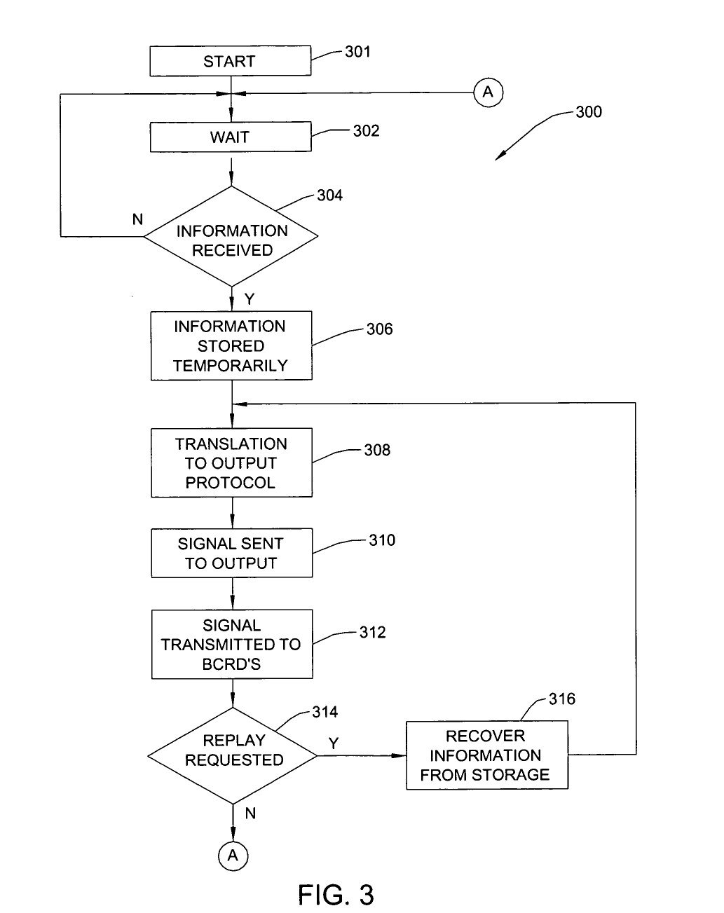

Referring now to FIG. 3, when reception unit 116 is turned on an interface process 300 is started at step 301. A wait mode 302 puts process 300 in standby enabling it to receive a signal whenever any ITU 100 transmits appropriate information. If no signal is received process 300 remains in wait mode 302. When a reception detection means 304 detects a signal from any ITU 100 it is stored in a temporary store 306 and sent to a translation unit 308. Translation unit 308 converts the information received into an appropriate protocol to be transmitted to BCRDs. After translation, the information is sent to an output unit 310, which transmits the signal to the BCRDs 312.

Process 300 will then return to wait mode 302 unless a replay request 314 is required. If a replay request 314 is signalled, the information is recovered from temporary store 306 by recovery means 316 and the information is communicated to translation unit 308.

Braille interface system 50 may be used to allow communication between a user using Braille interface glove 132 and a wide variety of information systems, such as computerized systems, computers, information systems, information signs, TV, interactive TV or any other system that transmits information. For example, a computer may transmit warning or information messages, such as, “mp3 download complete”. An information system, in the context of the present invention, may also include any individual visual sign or group of visual signs that contain information useful for users and/or the public in general, such as pedestrians on public areas, visitors within buildings or any person in need of visual information. The visual signs can be either real material signs of any kind or virtual signs such as pop-up windows on computer screens or messages on a display of an electronic device.

Information transmitted from information systems may be static or variable or a combination of both. Static information, in the context of the present invention, relates to information which does not change under any circumstance, for example a warning sign for a staircase. Variable information, in the context of the present invention, relates to information which may change depending on circumstances or status of the object that the sign is related to. For example, information relating to a pedestrian crossing will change depending on whether a green light or red light is on.

Braille glove interface 132 may be a full glove or just the finger section of a glove, the information is transmitted to the user's finger tips in the form of Braille signs simulated or reproduced in the inner part of the glove which is in contact with the finger tip.

The information may be transmitted to any other sensitive region of a user's digit or digits if appropriate.

The Braille glove interface 132 may operate in a multi-network seamless roaming mode enabling it to receive information from a variety of systems as required. Reception unit 116 may be able to receive information transmitted in a wide variety of formats, such as, for example, WiFi (Wireless Fidelity—also known as wireless networking), Bluetooth or infrared.

The information transmitted from the different systems can be short notifications or large text documents. As such, information is considered more advantageous being received by the visually impaired person in Braille code in preference to other formats, such as, voice, as listening comprehension is usually lower than reading comprehension.

Importantly, the present invention uses the second sense most developed by visually impaired person: the touch. The most developed sense, hearing, is then left free to be used for environment noises. The present invention also avoids the need to locate signs as the information flows to the visually impaired person instead of the visually impaired person having to find the sign.

Also, a new set of characters or signs may be implemented with the present invention for abbreviating the information flow. For example, in a pedestrian crossing the presence of a “Push button” for the traffic light can be indicated instead of letter by letter by a long 6 pin pressure, while the existence of a traffic light in red for the pedestrian by a short 12 pin pressure and a green light by a long 12 pin. Consequently, although the invention is described as a “Braille” interface system, the system may use other tactile characters than those traditionally used in Braille representation.

Also, the pressure can be sent to one digit of a user's hand or to more than one as needed for different frequent signs. Improvements and modifications may be incorporated without departing from the scope of the present invention.

1. A tactile interface comprising:
an attaching means for attaching the tactile interface to at least one digit of a user;
at least one tactile character reproduction device, located on the attaching means and proximal to a sensitive region of the at least one digit; and
a reception means for receiving transmitted information, wherein the reception means provides the received information to the at least one tactile character reproduction device.

2. The interface as claimed in claim 1, wherein the tactile interface is a Braille interface.

3. The interface as claimed in claim 1, wherein the attaching means is at least part of a glove.

4. The interface as claimed in claim 1 further comprising a storage means for storing information from the reception means and a playback means for resending the stored information to the at least one tactile character reproduction device.

5. The interface as claimed in claim 4 further comprising a translation means, wherein received information or stored information which is not in a format acceptable to the at least one tactile character reproduction device is translated by the translation means to a suitable format before being sent to the at least one tactile character reproduction device.

6. The interface as claimed in claim 1, wherein the reception means is a wireless reception means.

7. The interface as claimed claim 6, wherein the wireless reception means is adapted to receive transmitted information in one or more of the following communication means: RFID, Bluetooth, WiFi or Wireless networking, or infrared.

8. An information transmission unit comprising a transmission means for transmitting information to a tactile interface including an attaching means for attaching the tactile interface to at least one digit of a user;
at least one tactile character reproduction device, located on the attaching means and proximal to a sensitive region of the at least one digit; and
a reception means for receiving transmitted information, wherein the reception means provides the received information to the at least one tactile character reproduction device.

9. The unit as claimed in claim 8, wherein the tactile interface is a Braille interface.

10. The unit as claimed in claim 8 wherein the attaching means is at least part of a glove.

11. The unit as claimed in claim 8 further comprising a storage means for storing information from the reception means and a playback means for resending the stored information to the at least one tactile character reproduction device.

12. The unit as claimed in claim 11 further comprising a translation means, wherein received information or stored information which is not in a format acceptable to the at least one tactile character reproduction device is translated by the translation means to a suitable format before being sent to the at least one tactile character reproduction device.

13. The unit as claimed in claim 8, wherein the reception means is a wireless reception means.

14. The unit as claimed in claim 13, wherein the wireless reception means is adapted to receive transmitted information in one or more of the following communication means: RFID, Bluetooth, WiFi or Wireless networking, or infrared.

15. The unit as claimed in claim 8, wherein the transmission means is adapted to repeat the transmission of the stored information at a predetermined interval.

16. The unit as claimed in claim 15, further comprising an input means and a storage means, wherein the input means can receive information for transmission, the storage means can store the latest information received, and the transmission means can transmit the stored information.

17. The unit as claimed in claim 16, further comprising an output means, wherein an external source can access the storage means enabling verification of the stored information.

18. A tactile interface system comprising:
an information transmission unit having a transmission means for transmitting information to a tactile interface including an attaching means for attaching the tactile interface to at least one digit of a user;
at least one tactile character reproduction device, located on the attaching means and proximal to a sensitive region of the at least one digit; and
a reception means for receiving transmitted information, wherein the reception means provides the received information to the at least one tactile character reproduction device.

19. The system as claimed in claim 18, wherein the tactile interface is a Braille interface.

20. The system as claimed in claim 18, wherein the attaching means is at least part of a glove.
